(19) United States
(12) Patent Application Publication
(10) Pub. No.: US 2010/0010147 A1
(43) Pub. Date: Jan. 14, 2010

(54) ADHESIVES PREPARED FROM DIPHENYLETHYLENE CONTAINING BLOCK COPOLYMERS

(75) Inventor: David John St. Clair, Houston, TX (US)

Correspondence Address: KRATON POLYMERS U.S. LLC, 16400 Park Row, HOUSTON, TX, 77084, US

(73) Assignee: KRATON Polymer U.S. LLC, Huston, TX (US)

(21) Appl. No.: 12/168,978

(22) Filed: Jul. 8, 2008

(51) Int. Cl. C08L 53/00

(52) U.S. Cl. 524/505

(57) ABSTRACT

The present invention relates to adhesives and sealants prepared from novel anionic block copolymers of mono alkenyl arenes, diphenylethylenes and conjugated dienes. The block copolymers are unhydrogenated or selectively hydrogenated and have mono alkenyl arene/diphenylethylene end blocks and conjugated diene mid blocks. The block copolymer may be combined with tackifying resins, oils and other components to form the adhesives and sealants of the present invention.

### BACKGROUND OF THE INVENTION

1. Field of the Invention

The present invention relates to adhesives and sealants prepared from anionic block copolymers. The anionic block copolymers comprise at least one block comprising a mixture of 1,1-diphenylethylene and its derivatives with mono alkenyl arenes and at least one block comprising a conjugated diene or conjugated diene containing mixture selected from isoprene, butadiene, or mixtures of isoprene and butadiene. Said block copolymers may be unsaturated or hydrogenated.

2. Background of the Art

The preparation of block copolymers of mono alkenyl arenes and conjugated dienes is well known. One of the first patents on linear ABA block copolymers made with styrene and butadiene is U.S. Pat. No. 3,149,182. These polymers in turn could be hydrogenated to form more stable block copolymers, such as those described in U.S. Pat. No. 3,595,942 and U.S. Re. 27,145. Such polymers are broadly termed Styrenic Block Copolymers or SBC's.

SBC's have a long history of use as adhesives and sealants. For example, U.S. Pat. No. 3,239,478 (“Harlan”) discloses adhesives comprising unsaturated styrene-isoprene-styrene block copolymers (“SIS”) and styrene-butadiene-styrene block copolymers (“SBS”) in adhesives and sealants. Harlan also broadly discloses adhesives comprising the hydrogenated S-B-S (i.e. “SEBS”) and hydrogenated S-I-S (i.e. “SEPS”) block copolymers with tackifying resins and extender oils for a variety of adhesives and sealants, including pressure sensitive adhesives. A recent patent, U.S. Pat. No. 6,987,142, relates to adhesives and sealants containing a controlled distribution block copolymer.

The maximum temperature at which an adhesive can bear a load determines to a great extent those applications in which the adhesive can be used. For example, the suitability of a PSA tape for use at elevated temperatures will be limited by the temperature at which the PSA looses cohesive strength and can no longer bear a load. In labels, the temperature at which the label will bleed through a paper facestock will be limited by the temperature at which the PSA loses cohesive strength.

Now a novel anionic block copolymer based on mono alkenyl arene/diphenylethylene end blocks and conjugated diene mid blocks has been discovered. Methods for making such polymers are described in detail herein. Patentee has found that these new polymers will allow the preparation of improved adhesives. In particular, the adhesives have higher upper service temperature compared to conventional block copolymers.

### SUMMARY OF THE INVENTION

The present invention relates to novel adhesive compositions comprising 100 parts by weight of at least one novel block copolymer, 25 to 300 parts by weight of at least one tackifying resin, and 0 to 200 parts by weight of an extender oil. The novel block copolymer comprises one or more block copolymers having at least one A polymer block and at least one B polymer block wherein the A block represents a polymer block comprising mono alkenyl arenes and one or more monomers of the formula I:

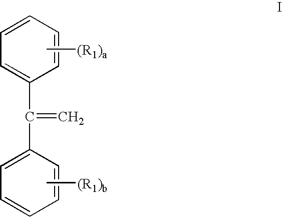

wherein R₁ is hydrogen or an alkyl of 1 to 22 carbon atoms, a is 0, 1, 2, 3, 4, or 5 and b is 0, 1, 2, 3, 4, or 5 and the B block represents a polymer block of a conjugated diene or a conjugated diene mixture. The block copolymer may be unhydrogenated (unsaturated) or selectively hydrogenated, if desired, where the B conjugated diene midblock is hydrogenated and the A styrene/diphenylethylene end block is not hydrogenated to any large extent.

The maximum glass transition temperature (Tg) that can be achieved using the prior art polystyrene endblocks is about 100° C. By copolymerizing diphenylethylene monomers (DPE) with styrene in the endblocks, it is possible to make polymers which have Tg>100° C. The upper service temperature of the block copolymer is directly related to the Tg of the end block phase. The higher the Tg, the higher will be the temperature at which the end blocks loose their integrity. As shown in the examples which follow, adhesives made with the novel block copolymers have significantly higher upper service temperature, making them useful for adhesives and sealants requiring use at elevated temperatures.

### DETAILED DESCRIPTION OF THE PREFERRED EMBODIMENTS

The adhesives of the present invention contain a novel block copolymer. The block copolymer compositions of the present invention preferably contain one or more block copolymers having a structure prior to hydrogenation of A-B, A-B-A, (A-B)ₙ, (A-B)ₙX, (A-B-A)ₙ, or (A-B-A)ₙX wherein A represents a polymer block of a mixture of one or more mono alkenyl arenes and one or more monomers of the general formula I:

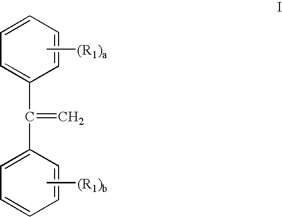

wherein R₁ is hydrogen or an alkyl of 1 to 22 carbon atoms, a is 0, 1, 2, 3, 4, or 5 and b is 0, 1, 2, 3, 4, or 5, B represents a polymer block of a conjugated diene or conjugated dienes mixture; n is an integer from 1 to 30 and X represents the residue of a coupling agent.

With regard to the various block copolymer structures, each A block represents a polymer block of a mixture of one or more mono alkenyl arenes and one or more monomers of 1,1-diphenylethylene or its derivatives. While the mono alkenyl arenes utilized may be any mono alkenyl arene known for use in the preparation of block copolymers such as styrene, o-methylstyrene, p-methylstyrene, p-tert-butylstyrene, 2,4-dimethylstyrene, alpha-methylstyrene, vinylnaphthalene, vinyltoluene and vinylxylene or mixtures thereof, the most preferred mono alkenyl arene for use in the preparation of the block copolymers of the present invention is styrene, which is used as a substantially pure monomer or as a major component in mixtures with minor proportions of other structurally related alkenyl aromatic monomer(s) such as o-methylstyrene, p-methylstyrene, p-tert-butylstyrene, 2,4-dimethylstyrene, α-methylstyrene, vinylnaphtalene, vinyltoluene and vinylxylene, i.e., in proportions of at most 10% by weight. The use of substantially pure styrene is most preferred.

In addition to the mono alkenyl arenes, each A block comprises one or more 1,1-diphenylethylenes or its derivatives, particularly of the formula I:

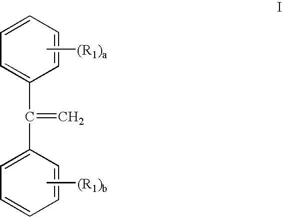

wherein R₁ is hydrogen or an alkyl of 1 to 22 carbon atoms, a is 0, 1, 2, 3, 4, or 5 and b is 0, 1, 2, 3, 4, or 5. In formula I, the aromatic rings may be substituted by an alkyl group having up to 22 carbon atoms. Preferred alkyl substituents are alkyl groups having from 1 to 4 carbon atoms such as methyl, ethyl, isopropyl, n-propyl, n-butyl, isobutyl and tert-butyl. When the aromatic rings are substituted by an alkyl group, there may be from 1 to 5 substituents. When the aromatic ring is substituted, preferably the degree of substitution will be from 1 to 3 alkyl substituents, more preferably 1. However, the unsubstituted 1,1-diphenylethylene is particularly preferred.

The weight ratio of 1,1-diphenylethylene or its derivatives of the formula I to monoalkenyl arenes in the block copolymers is generally within the range of from 3:97 to 70:30, preferably within the range of from 15:85 to 60:40.

Each of the B blocks of the block copolymers is represented by conjugated dienes selected from butadiene, isoprene and mixtures thereof. In one embodiment of the present invention, the conjugated diene is butadiene. In an alternative embodiment, the conjugated diene is a mixture of butadiene and isoprene wherein the ratio of butadiene to isoprene is from 20:80 to 80:20. When the B polymer block comprises a mixture of butadiene and isoprene, the polymer block will be a randomly polymerized block of butadiene and isoprene.

A variety of coupling agents are known in the art and can be used in preparing the coupled block copolymers of the present invention. These include, for example, dihaloalkanes, silicon halides, siloxanes, multifunctional epoxides, esters of monohydric alcohols with carboxylic acids, (e.g. methylbenzoate and dimethyl adipate) and epoxidized oils. Star-shaped polymers are prepared with polyalkenyl coupling agents as disclosed in, for example, U.S. Pat. Nos. 3,985,830; 4,391,949; and 4,444,953; as well as Canadian Patent No. 716,645, each incorporated herein by reference. Suitable polyalkenyl coupling agents include divinylbenzene, and preferably m-divinylbenzene. Preferred are tetra-alkoxysilanes such as tetra-methoxysilane (TMOS) and tetra-ethoxysilane (TEOS), tri-alkoxysilanes such as methyltrimethoxysilane (MTMS), aliphatic diesters such as dimethyl adipate and diethyl adipate, and diglycidyl aromatic epoxy compounds such as diglycidyl ethers deriving from the reaction of bis-phenol A and epichlorohydrin.

The molecular weight of the various blocks in the block copolymers is also an important factor in preparing the adhesives of the present invention. For each A block the desired block weights are 3,000 to about 60,000, preferably about 5,000 to about 50,000. For each B block the desired block weights are about 20,000 to about 200,000, preferably about 20,000 to about 150,000. As used herein, the term “molecular weights” refers to the true molecular weight in g/mol of the polymer or block of the copolymer. The molecular weights referred to in this specification and claims can be measured with gel permeation chromatography (GPC) using polystyrene calibration standards, such as is done according to ASTM 3536. GPC is a well-known method wherein polymers are separated according to molecular size, the largest molecule eluting first. The chromatograph is calibrated using commercially available polystyrene standards of known molecular weight. The molecular weight of polymers measured using GPC so calibrated are styrene equivalent molecular weights. The styrene equivalent molecular weight may be converted to true molecular weight when the styrene content of the polymer and the vinyl content of the diene segments are known. The detector used is preferably a combination ultraviolet and refractive index detector. The molecular weights expressed herein are measured at the peak of the GPC trace, and are expressed as styrene equivalent molecular weights.

With regard to the coupled block copolymers, the Coupling Efficiency (“CE”) will typically be from about 70 to 98 weight percent, preferably about 80 to about 98 weight percent. Coupling Efficiency is defined as the proportion of polymer chain ends which were living, P—Li, at the time the coupling agent was added that are linked via the residue of the coupling agent at the completion of the coupling reaction. In practice, Gel Permeation Chromatography (GPC) data are used to calculate the coupling efficiency for a polymer product.

The percentage of A blocks in the block copolymer composition is desired to be about 5 to about 50 weight percent, preferably about 10 to about 40 weight percent.

Another important aspect of the present invention is to control the microstructure or vinyl content of the conjugated diene in the B block. The term “vinyl content” refers to a conjugated diene which is polymerized via 1,2-addition (in the case of butadiene—it would be 3,4-addition in the case of isoprene). Although a pure “vinyl” group is formed only in the case of 1,2-addition polymerization of 1,3-butadiene, the effects of 3,4-addition polymerization of isoprene (and similar addition for other conjugated dienes) on the final properties of the block copolymer will be similar. The term “vinyl” refers to the presence of a pendant vinyl group on the polymer chain. When referring to the use of butadiene as the conjugated diene, it is preferred that about 10 to about 80 mol percent of the condensed butadiene units in the copolymer block have 1,2 vinyl configuration as determined by proton NMR analysis, preferably about 25 to about 80 mol percent of the condensed butadiene units should have 1,2-vinyl configuration. When referring to the use of isoprene as the conjugated diene, it is preferred that about 5 to about 80 mol percent of the condensed isoprene units in the copolymer block have 3,4 vinyl configuration. Vinyl content is effectively controlled by varying the relative amount of the microstructure modifying agent in the solvent mixture. Such materials include ethers such as diethyl ether (DEE) or for higher vinyl contents, diethoxy propane (DEP). Suitable ratios of modifying agent to lithium are disclosed and taught in US Pat. Re 27,145, which disclosure is incorporated by reference.

The block copolymer utilized in the adhesives of the present invention may be unsaturated or selectively hydrogenated. Hydrogenation can be carried out via any of the several hydrogenation or selective hydrogenation processes known in the prior art. For example, such hydrogenation has been accomplished using methods such as those taught in, for example, U.S. Pat. Nos. 3,494,942; 3,634,594; 3,670,054; 3,700,633; and Re. 27,145. Hydrogenation can be carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. In that case, the double bonds of both the conjugated diene and arene may be reduced by 90 percent or more.

One of the components used in the adhesives and sealants of the present invention is a tackifying resin. Tackifying resins include both end block compatible resins and mid block compatible resins. The end block compatible resin may be selected from the group consisting of coumarone-indene resin, polyindene resin, poly(methyl indene) resin, polystyrene resin, vinyltoluene-alphamethylstyrene resin, alphamethylstyrene resin and polyphenylene ether, in particular poly(2,6-dimethyl-1,4-phenylene ether). Such resins are e.g. sold under the trademarks “HERCURES”, “ENDEX”, “KRISTALEX”, “NEVCHEM” and “PICCOTEX”. Resins compatible with the mid block may be selected from the group consisting of compatible C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosins esters, rosin derivatives and mixtures thereof These resins are e.g. sold under the trademarks “REGALITE”, “REGALREZ”, “ESCOREZ”, “WINGTACK” and “ARKON”.

Another one of the components used in the adhesives and sealants of the present invention is a polymer extending oil or plasticizer. Especially preferred are the types of oils that are compatible with the elastomeric segment of the block copolymer. While oils of higher aromatics content are satisfactory, those petroleum-based white oils having low volatility and less than 50% aromatic content are preferred. Such oils include both paraffinic and naphthenic oils. The oils should additionally have low volatility, preferable having an initial boiling point above about 500° F.

Examples of alternative plasticizers which may be used in the present invention are oligomers of randomly or sequentially polymerized styrene and conjugated diene, oligomers of conjugated diene, such as butadiene or isoprene, liquid polybutene-1, and ethylene-propylene-diene rubber, all having a weight average molecular weight in the range from 300 to 35,000, preferable less than about 25,000 mol weight.

The amount of oil or plasticizer employed varies from about 0 to about 300 parts by weight per hundred parts by weight rubber, or block copolymer, preferably about 20 to about 150 parts by weight.

Various types of fillers and pigments can be included in the adhesive formulations to pigment the adhesive and reduce cost. Suitable fillers include calcium carbonate, clay, talc, silica, zinc oxide, titanium dioxide and the like. The amount of filler usually is in the range of 0 to 30% weight based on the solvent free portion of the formulation, depending on the type of filler used and the application for which the adhesive is intended. An especially preferred filler is titanium dioxide.

If the adhesive is to be applied from solvent solution, the organic portion of the formulation will be dissolved in a solvent or blend of solvents. Aromatic hydrocarbon solvents such as toluene, xylene or Shell Cyclo Sol 53 are suitable. Aliphatic hydrocarbon solvents such as hexane, naphtha or mineral spirits may also be used. If desired, a solvent blend consisting of a hydrocarbon solvent with a polar solvent can be used. Suitable polar solvents include esters such as isopropyl acetate, ketones such as methyl isobutyl ketone, and alcohols such as isopropyl alcohol. The amount of polar solvent used depends on the particular polar solvent chosen and on the structure of the particular polymer used in the formulation. Usually, the amount of polar solvent used is between 0 and 50% wt in the solvent blend.

The compositions of the present invention may be modified further with the addition of other polymers, oils, fillers, reinforcements, antioxidants, stabilizers, fire retardants, anti blocking agents, lubricants and other rubber and plastic compounding ingredients without departing from the scope of this invention. Such components are disclosed in various patents including U.S. Pat. No. 3,239,478; and U.S. Pat. No 5,777,043, the disclosures of which are incorporated by reference.

The compositions of the present invention may be designed for a wide variety of uses and applications. They may be applied to paper, paper boards, wood, metal foils, polyolefin films, polyvinyl chloride films, cellophane, felts, woven fabrics, non-woven fabrics, glass, etc., and for bonding two or more of such materials together. The adhesives are useful in pressure sensitive tapes, such as masking tapes, adhesive sheets, primers for other adhesives, adhesive tapes, mending tapes, electrical insulation tape, laminates, hot-melt adhesives, mastics, cements, caulking compounds, binders, sealants, delayed tack adhesives, adhesive lattices, carpet backing, etc.

Regarding the relative amounts of the various ingredients, this will depend in part upon the particular end use and on the particular block copolymer that is selected for the particular end use. Table A below shows some notional compositions that are included in the present invention. “DPE Copolymer” refers to the novel block copolymers of the present invention having diphenylethylene/styrene end blocks:

TABLE A
Applications, Compositions and Ranges

| Application | Ingredients | Parts by Weight |
|---|---|---|
| Adhesive | DPE Copolymer | 100 |
| | Tackifying Resin | 25 to 300 |
| | Extending Oil | 0 to 200 |
| Hot melt adhesive | DPE Copolymer | 100 (preferred range) |
| | Tackifying Resin | 75 to 200 |
| | End Block Resin | 0 to 50 |
| | Extending Oil | 0 to 150 |
| Solvent based adhesive | DPE Copolymer | 100 (not including |
| | | solvent) |
| | Tackifying Resin | 25 to 300 |
| | End Block Resin | 0 to 50 |
| | Extending Oil | 0 to 150 |
| Solvent based adhesive | DPE Copolymer | 100 (not including |
| | | solvent) |
| | Tackifying resin | 25 to 300 |
| | Oil | 0 to 100 |
| Pressure sensitive adhesive | DPE Copolymer | 100 |
| | Tackifying Resin | 50 to 500 |
| | Oil | 0 to 200 |
| Construction adhesive | DPE Copolymer | 100 |
| or sealant | Tackifying Resin | 0 to 200 |
| | Endblock Resin | 0 to 200 |
| | Calcium Carbonate | 100 to 800 |

### EXAMPLES

The following examples are provided to illustrate the present invention. The examples are not intended to limit the scope of the present invention and they should not be so interpreted. Amounts are in weight parts or weight percentages unless otherwise indicated. The test methods used in the examples are American Society for Testing Materials (ASTM) test methods, and the following specific methods were used:
Rolling ball tack ASTM D-3121
Polyken probe tack ASTM D-2979
Loop Tack ASTM D-6195
180° Peel ASTM D-903
Holding Power ASTM D-6463
SAFT ASTM D-4498
Melt Viscosity ASTM D-3236
Heat Aging Viscosity Stability ASTM D-4499

### Example 1

The following details the synthesis of the block copolymers employed in the present invention. Table 1 below details the overall structure of the resulting polymers.

### EDF 9925

Cyclohexane (45.75 kg) was charged into a stainless steel autoclave (1). Diethyl ether (30.5 g) was added, followed by 1,1-diphenylethylene (7.06 kg). The mixture was titrated with sec-BuLi (1.3 M) to a visual endpoint while the temperature was maintained at 50° C. Excess sec-BuLi (1157 mL, 1.3 M) was then added to the autoclave and styrene (8.29 kg) was subsequently charged to the autoclave at a dosing rate of 0.38 kg/min. The temperature of the autoclave was maintained at about 50° C. for 103 minutes. During this time a second autoclave was charged with cyclohexane (202.93 kg) and diethyl ether (17.111 kg) and the temperature was maintained at 40° C. until transfer. The mixture was titrated with sec-BuLi after which 50.3 kg of the reaction mixture in autoclave 1 was transferred to autoclave 2. Butadiene (23.98 kg) was added during which the temperature in the autoclave rose to 58° C. At 21 minutes after transfer methyltrimethoxysilane (65.1 g) was added. After coupling was completed, the polymer was hydrogenated to selectively hydrogenate the butadiene polymer block, and then the selectively hydrogenated block copolymer was stabilized with standard stabilizers and recovered via steam stripping, under conditions typical for hydrogenated polymers.

### FWO7-264

Cyclohexane (3.50 kg) was charged into a 10 Liter stainless steel autoclave (1). Diethyl ether (2.2 g) was added, followed by 1,1-diphenylethylene (402.7 g). The mixture was heated to 50° C. and maintained at that temperature until transfer. Excess sec-BuLi (105 mL, 0.6 M) was then added to the autoclave and styrene (472.6 g) was subsequently charged to the autoclave at a dosing rate of 32 g/min. After 82 minutes the content of autoclave 1 was transferred to autoclave 2 (stainless steel, 30 L) which was already charged with cyclohexane (9.68 kg) and heated to 60° C. Butadiene (1.85 kg) was added to the reaction mixture at a rate of 44 g/min, during which the temperature rose to 87° C. Eleven minutes after full addition of butadiene, the coupling agent, isobutyl-trimethoxysilane (3.7 g) was added. After 18 minutes methanol was added. The polymer mixture was stabilized with standard stabilizers, after which the polymer was isolated through hot water coagulation.

### FWO7-265

Cyclohexane (3.50 kg) was charged into a 10 Liter stainless steel autoclave (1). Diethyl ether (2.2 g) was added, followed by 1,1-diphenylethylene (402.7 g). The mixture was heated to 50° C. and maintained at that temperature until transfer. Excess sec-BuLi (106 mL, 0.6 M) was then added to the autoclave and styrene (474.4 g) was subsequently charged to the autoclave at a dosing rate of 26 g/min. After 101 minutes the content of autoclave 1 was transferred to autoclave 2 (stainless steel, 30 L) which was already charged with cyclohexane (9.64 kg) and heated to 60° C. Butadiene (1.84 kg) was added to the reaction mixture at a rate of 44 g/min, during which the temperature rose to 87° C. Six minutes after full addition of butadiene, the coupling agent, isobutyl-trimethoxysilane (3.7 g) was added. After 14 minutes methanol was added. The polymer mixture was stabilized with standard stabilizers, after which the polymer was isolated through hot water coagulation.

TABLE #1

| | Apparent | | | | | | |
|---|---|---|---|---|---|---|---|
| | Molecular | | | | | | 3 and |
| | Weight of 2 | | | | | | 4 |
| | Arm Fraction | Si/Li | CE | Vinyl | 1 Arm | 2 Arm | Arm |
| EDF 9225 | 111 | 0.38 | 95 | 37 | 4 | 83 | 3 |
| FW07-264 | 160 | 0.33 | 74 | 10 | 25 | 38 | 32 |
| FW07-265 | 160 | 0.33 | 83 | 11 | 17 | 56 | 27 |

“Apparent Molecular Weight” values are in thousands,
“Si/Li” is the ratio of tetramethoxysilane coupling agent to s-BuLi initiator,
“CE” is coupling efficiency,
Vinyl refers to the 1,2-content of the butadiene portion of the polymer,
1 Arm is uncoupled diblock,
2 Arm is the linear triblock copolymer,
3 and 4 Arm polymers are radial in structure.

### Example 2

This example compares the performance of two sequentially polymerized, selectively hydrogenated, SEBS polymers, one containing polystyrene end blocks (Polymer A) and one containing endblocks which are a copolymer of 40% w styrene and 60% w DPE (EDF 9225). The endblock MW of both polymers is about 10,000 g/mole and the midblock MW of both polymers is about 50,000 gm/mole. Performances of Polymer A and EDF 9225 are shown in Table #2. Properties were measured in adhesive formulations with varying polymer contents. Results show differences in tack, peel and shear are small. The main differences are in melt viscosity and SAFT. At a given polymer content, EDF 9225 gives higher SAFT but also higher melt viscosity. However, less polymer is required to reach a given SAFT with EDF 9225 than with Polymer A and so EDF 9225 gives a lower melt viscosity. For example, about 14% w EDF 9225 is required to reach 100° C. SAFT while about 28% PolymerAis required to reach 100° C. SAFT. Melt viscosity at 14% w EDF 9225 is only about 1 Pa·s while melt viscosity at 28% Polymer A is 20 Pa·s.

TABLE #2

| | 1 | 2 | 3 | 4 | 5 | 6 |
|---|---|---|---|---|---|---|
| Composition, % w | | | | | | |
| Polymer A | 20 | 25 | 30 | | | |
| EDF 9225 | | | | 15 | 20 | 25 |
| Regalite R91 | 52.4 | 51.1 | 49.7 | 53.7 | 52.4 | 51.1 |
| Drakeol 34 | 27.6 | 23.9 | 20.3 | 31.3 | 27.6 | 23.9 |
| Irganox 1010 | 0.2 | 0.2 | 0.2 | 0.2 | 0.2 | 0.2 |
| Melt Vis @ 177° C., Pa · s | 2.7 | 8.5 | 25 | 1.4 | 7.0 | 25 |
| Properties^{a)} | | | | | | |
| Thickness, mil | 2.4 | 2.9 | 2.9 | 2.9 | 2.7 | 2.7 |
| Rolling ball tack, cm | 2.6 | 2.8 | 2.6 | 1.5 | 2.3 | 2.1 |
| Polyken probe tack, kg | 0.48 | 0.47 | 0.47 | 0.51 | 0.54 | 0.53 |
| Loop tack, oz/in | 3.0 | 4.0 | 3.8 | 4.0 | 4.5 | 4.7 |
| 180° Peel, pli | 1.9 | 1.7 | 2.1 | 2.0 | 2.3 | 2.6 |
| HP to steel, 1 × 1″, 2 kg, min | >5000 | >5000 | >5000 | 1560 | >5000 | >5000 |
| SAFT, ° C. | 85 | 95 | 102 | 102 | 114 | 117 |

^{a)}The blends were dissolved at 40% w in toluene and cast on Mylar.

### Example 3

This example compares the performance of three unsaturated SBS type polymers containing polystyrene end blocks (Polymers B, C and D) with two similar polymers containing end blocks which are a copolymer of styrene and diphenylethylene (FWO7-264 and FW07-265). Polymers B and C are linear, coupled (S—B)₂ polymers containing about 30% w styrene and having a coupling efficiency of 84%. MW's ofthe S and B blocks prior to coupling of Polymer B are 10,000 gm/mole and 23,000 gm/mole, respectively. MW's of the S and B blocks prior to coupling of Polymer C are 16,000 gm/mole and 37,000 gm/mole, respectively. Polymer D is a radial, coupled (S—B)₄ polymer containing 30% w styrene and having a coupling efficiency of 84%. MW's of the S and B blocks prior to coupling are 21,000 gm/mole and 50,000 gm/mole, respectively. FWO7-264 and -265 are coupled (S/DPE-B)_{2.5} polymers where the end blocks contain 40% w styrene and 60% w DPE and the end block MW is about 12,000 gm/mole, the B midblock MW is 28,000 gm/mole, and the coupling efficiency is 74 and 84%. Performances of these five polymer were compared in a PSA formulation containing 30% w polymer. Results are in Table #3. Again differences in tack, peel and shear are small. The main differences are again in SAFT. Although the S/DPE end block MW of FWO7-264 and -265 is intermediate between those of Polymers B and C, FWO7-264 and -265 give much higher SAFT than Polymers B and C. In fact, they give SAFT values comparable to those of Polymer D which has much higher end block MW. It is expected that the advantage of FWO7-264 and -265 would be that they would give lower solution viscosity than Polymer D and therefore could be coated at higher solids content.

TABLE #3

| | 7 | 8 | 9 | 10 | 11 |
|---|---|---|---|---|---|
| Composition, % w | | | | | |
| Polymer B | 30 | | | | |
| Polymer C | | 30 | | | |
| Polymer D | | | 30 | | |
| FW07-264 | | | | 30 | |
| FW07-265 | | | | | 30 |
| Piccolyte A115 | 50 | 50 | 50 | 50 | 50 |
| Nyflex 222 | 20 | 20 | 20 | 20 | 20 |
| Irganox 1010 | 0.2 | 0.2 | 0.2 | 0.2 | 0.2 |
| Properties^{a)} | | | | | |
| Rolling ball tack, cm | 3.2 | 1.3 | 1.0 | 2.1 | 1.0 |
| Polyken probe tack, kg | 0.82 | 0.96 | 0.84 | 0.88 | 0.96 |
| Loop tack, oz/in | 5.4 | 6.6 | 7.6 | 6.8 | 9.5 |
| 180° Peel, pli | 4.1 | 5.0 | 5.3 | 5.4 | 6.0 |
| HP to steel, 1 × 1″, 2 kg, | >70 | >70 | >70 | >70 | >70 |
| hr | | | | | |
| SAFT, ° C. | 89 | 112 | 140 | 144 | 143 |
| Finger tack | tacky | tacky | tacky | tacky | tacky |

^{a)}Adhesives were cast on 1 mil Mylar at 1.4 mil DFT.

What is claimed:

1. An adhesive composition comprising 100 parts by weight of at least one hydrogenated block copolymer, about 25 to about 300 parts by weight of a tackifying resin and about zero to about 200 parts by weight of an extending oil, wherein said hydrogenated block copolymer comprises an A-B-A, an (A-B)n or an (A-B)n-X polymer wherein:
i. A comprises a polymer block of a monoalkenyl arene and one or more 1,1-diphenylethylenes or its derivatives of the formula I: 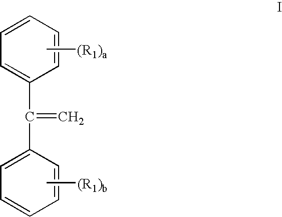
wherein R₁ is hydrogen or an alkyl of 1 to 22 carbon atoms, a is 0, 1, 2, 3, 4, or 5 and bis 0, 1, 2, 3, 4, or 5.;
ii. B represents a polymer block of a hydrogenated conjugated diene;
iii. n is an integer from 2 to 30; and
iv. X represents the residue of coupling agent.

2. The adhesive composition according to claim 1 wherein the weight ratio of monoalkenyl arene to 1,1-diphenylethylene is from 97:3 to 30:70.

3. The adhesive composition according to claim 2 wherein said mono alkenyl arene is styrene, said 1,1-diphenylethylene is unsubstituted and said conjugated diene is selected from the group consisting of isoprene and butadiene.

4. The adhesive composition according to claim 3 wherein said conjugated diene is butadiene, and wherein prior to hydrogenation about 10 to about 80 mol percent of the condensed butadiene units in block B have 1,2-configuration.

5. The adhesive composition according to claim 3 wherein said coupling agent is an alkoxy silane coupling agent selected from the group consisting of tetraethoxy silane, tetramethoxy silane, tetrabutoxy silane, methyl trimethoxy silane, methyl triethoxy silane, phenyl trimethoxy silane and isobutyl trimethoxy silane.

6. The adhesive composition according to claim 3 wherein said A blocks have a number average molecular weight of between about 5,000 and about 60,000, and wherein said B blocks have a number average molecular weight of between about 10,000 and about 200,000.

7. The adhesive composition according to claim 6 wherein the weight ratio of polymer block A to polymer block B is from 5/95 to 50/50.

8. The adhesive composition according to claim 7 also comprising 0 to about 50 parts by weight of an end block resin.

9. The adhesive composition according to claim 1 wherein said tackifying resin is selected from the group consisting of C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosins esters, rosin derivatives and mixtures thereof.

10. The adhesive composition according to claim 1 wherein said tackifying resin is selected from the group consisting of coumarone-indene resin, polyindene resin, poly(methyl indene) resin, polystyrene resin, vinyltoluene-alphamethylstyrene resin, alphamethylstyrene resin, polyphenylene ether and mixtures thereof.

11. The adhesive composition according to claim 1 wherein said extending oil is a petroleum-based white oil having an aromatics content less than about 50 weight percent.

12. The adhesive composition according to claim 1 also comprising additional components selected from the groups consisting of antioxidants, stabilizers, fillers, and additional auxiliaries.

13. An adhesive composition comprising 100 parts by weight of at least one unhydrogenated block copolymer, about 25 to about 300 parts by weight of a tackifying resin and about zero to about 200 parts by weight of an extending oil, wherein said unhydrogenated block copolymer comprises an A-B-A, (A-B)n or (A-B)n-X polymer wherein:
i. A comprises a polymer block of a monoalkenyl arene and one or more 1,1-diphenylethylenes or its derivatives of the formula I: 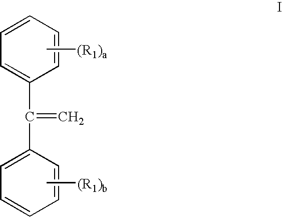
wherein R₁ is hydrogen or an alkyl of 1 to 22 carbon atoms, a is 0, 1, 2, 3, 4, or 5 and b is 0, 1, 2, 3, 4, or 5.;
ii. B represents a polymer block of a conjugated diene;
iii. n is an integer from 2 to 30; and
iv. X represents the residue of coupling agent.

14. The adhesive composition according to claim 13 wherein the weight ratio of monoalkenyl arene to 1,1-diphenylethylene is from 97:3 to 30:70.

15. The adhesive composition according to claim 14 wherein said mono alkenyl arene is styrene, said 1,1-diphenylethylene is unsubstituted and said conjugated diene is selected from the group consisting of isoprene and butadiene.

16. The adhesive composition according to claim 15 wherein said conjugated diene is butadiene, and wherein about 10 to about 80 mol percent of the condensed butadiene units in block B have 1,2-configuration.

17. The adhesive composition according to claim 15 wherein said coupling agent is an alkoxy silane coupling agent selected from the group consisting of tetraethoxy silane, tetramethoxy silane, tetrabutoxy silane, methyl trimethoxy silane, methyl triethoxy silane, phenyl trimethoxy silane and isobutyl trimethoxy silane.

18. The adhesive composition according to claim 15 wherein said A blocks have a number average molecular weight of between about 5,000 and about 60,000, and wherein said B blocks have a number average molecular weight of between about 10,000 and about 200,000.

19. The adhesive composition according to claim 18 wherein the weight ratio of polymer block A to polymer block B is from 5/95 to 50/50.

20. The adhesive composition according to claim 19 also comprising 0 to about 50 parts by weight of an end block resin.

21. The adhesive composition according to claim 13 wherein said tackifying resin is selected from the group consisting of C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosins esters, rosin derivatives and mixtures thereof.

22. The adhesive composition according to claim 13 wherein said tackifying resin is selected from the group consisting of coumarone-indene resin, polyindene resin, poly(methyl indene) resin, polystyrene resin, vinyltoluene-alphamethylstyrene resin, alphamethylstyrene resin, polyphenylene ether and mixtures thereof.

23. The adhesive composition according to claim 13 wherein said extending oil is a petroleum-based white oil having an aromatics content less than about 50 weight percent.

24. The adhesive composition according to claim 13 also comprising additional components selected from the groups consisting of antioxidants, stabilizers, fillers, and additional auxiliaries.
